(19) United States
(12) Patent Application Publication
(10) Pub. No.: US 2026/0044103 A1
(43) Pub. Date: Feb. 12, 2026

(54) SHEET FEEDING APPARATUS AND IMAGE FORMING APPARATUS

(71) Applicant: CANON KABUSHIKI KAISHA, Tokyo (JP)

(72) Inventor: KUNIHIRO NIWA, Shizuoka (JP)

(21) Appl. No.: 19/287,621

(22) Filed: Jul. 31, 2025

(30) Foreign Application Priority Data
Aug. 9, 2024 (JP) 2024-133937

(51) Int. Cl. G03G 15/00

(52) U.S. Cl. CPC G03G 15/6511; G03G 15/6558

(57) ABSTRACT

A sheet feeding apparatus includes an apparatus main body, a cassette configured to accommodate a sheet and withdrawably mounted on the apparatus main body, the cassette including a return member configured to move to a first position and a second position, a feed member configured to feed the sheet in a sheet feeding direction, and a separation member configured to form a nip portion with the feed member. The return member is configured to, in a state where the cassette is mounted on the apparatus main body, move from the second position to the first position.

### BACKGROUND

### Field of the Technology

The present disclosure relates to a sheet feeding apparatus for feeding sheets and an image forming apparatus for forming images on sheets.

### Description of the Related Art

Japanese Patent Application Laid-Open No. 2019-116367 discusses a feeding apparatus including a feed cassette that can be detachably mounted on the apparatus main body of an image forming apparatus, a supply roller and a feed roller that feed sheets from the feed cassette, and a separation roller that forms a separation nip with the feed roller. Japanese Patent Application Laid-Open No. 2019-116367 also discusses return levers that push back sheets upstream of the separation nip.

According to Japanese Patent Application Laid-Open No. 2019-116367, the return levers are disposed on the apparatus main body.

### SUMMARY

The present disclosure is directed to providing a new form of sheet feeding apparatus and image forming apparatus concerning a return member that pushes back sheets.

According to some embodiments of the present disclosure, a sheet feeding apparatus includes an apparatus main body, a cassette configured to accommodate a sheet and withdrawably mounted on the apparatus main body, the cassette including a return member configured to move to a first position and a second position, a feed member configured to feed the sheet in a sheet feeding direction, and a separation member configured to form a nip portion with the feed member, the separation member being configured to allow a first sheet with which the feed member is in contact to pass through the nip portion, wherein the separation member is configured to, when at least one second sheet is conveyed to the nip portion along with the first sheet, prevent the at least one second sheet from passing through the nip portion, and wherein the return member is configured to, in a state where the cassette is mounted on the apparatus main body, move from the second position to the first position so that the at least one second sheet is pushed back upstream of the nip portion in the sheet feeding direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an image forming apparatus according to a first exemplary embodiment.

FIG. 2 is a sectional view of a sheet feeding unit according to the first exemplary embodiment.

FIG. 3 is a perspective view of a feed unit and a driving device according to the first exemplary embodiment.

FIGS. 4A and 4B are explanatory diagrams illustrating the feed unit according to the first exemplary embodiment.

FIGS. 5A and 5B are perspective views of a separation unit according to the first exemplary embodiment.

FIGS. 6A, 6B, and 6C are explanatory diagrams illustrating a feed operation according to the first exemplary embodiment.

FIGS. 7A, 7B, and 7C are explanatory diagrams illustrating the separation unit according to the first exemplary embodiment.

FIG. 8 is an explanatory diagram illustrating a stopper according to the first exemplary embodiment.

FIG. 9 is a perspective view of a separation unit according to a second exemplary embodiment.

FIGS. 10A, 10B, and 10C are explanatory diagrams illustrating the separation unit according to the second exemplary embodiment.

### DESCRIPTION OF THE EMBODIMENTS

Various exemplary embodiments, features, and aspects of the present disclosure will be described below with reference to the drawings.

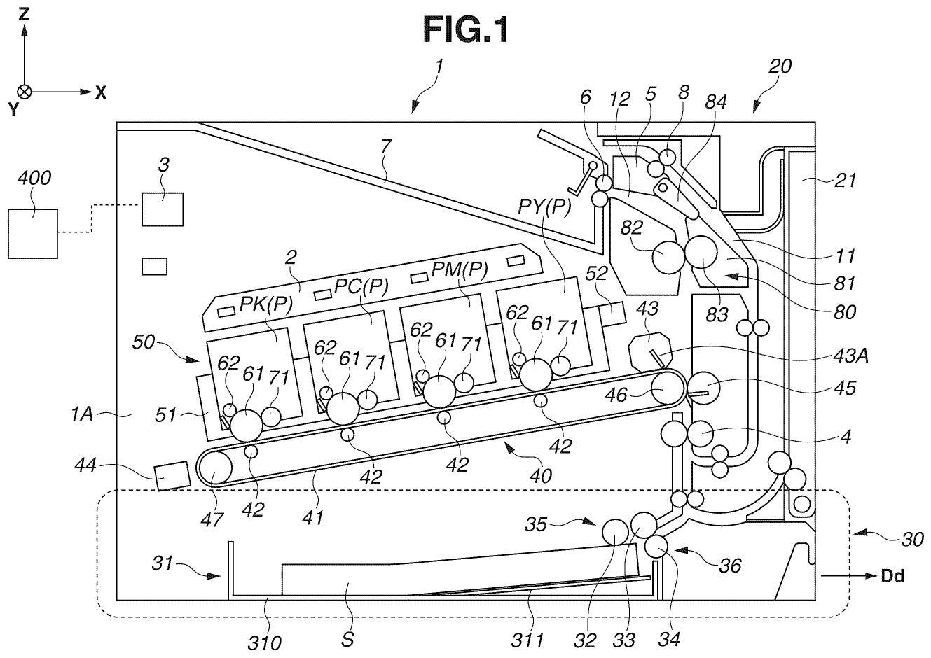

FIG. 1 is a schematic diagram illustrating a cross section of a printer 1 serving as an image forming apparatus according to a first exemplary embodiment.

The printer 1 is an electrophotographic color laser beam printer that forms images on sheets S serving as recording materials.

X, Y, and Z directions will be defined as illustrated in FIG. 1. The Z direction is a top-to-bottom direction (vertical direction) when the printer 1 is installed on a horizontal surface. The Y direction is the direction of the rotation axes of photosensitive drums 61 included in the printer 1. The X direction is a direction intersecting both the Z and Y directions. The X, Y, and Z directions are desirably orthogonal to each other. For the printer 1 according to the present exemplary embodiment, the X direction may be referred to as a front-to-rear direction, the Y direction a left-to-right direction, and the Z direction the top-to-bottom direction. In the present exemplary embodiment, the rightward direction in FIG. 1 is the forward direction (front) of the printer 1.

As illustrated in FIG. 1, the printer 1 includes an apparatus main body 1A (housing), a scanner 2 (exposure device), a control unit 3, a sheet feeding unit 30, a transfer unit 40, a cartridge tray unit 50, and a fixing device 80. The scanner 2, the control unit 3, the sheet feeding unit 30, and the fixing device 80 are accommodated in the apparatus main body 1A. The transfer unit 40 and the cartridge tray unit 50 are both withdrawably mounted on the apparatus main body 1A. The cartridge tray unit 50 and the transfer unit 40 are an example of an image forming unit for forming images on sheets S. Instead of such an intermediate transfer image forming unit, a direct transfer image forming unit or a non-electrophotographic (for example, inkjet) image forming unit may be used.

The sheet feeding unit 30 includes a sheet cassette 31 (also referred to as a sheet tray or a container) where sheets S serving as recording materials are stacked, a feed unit 35 serving as a feed unit for feeding the sheets S, and a separation unit 36 for separating the sheets S one by one. Details of the sheet feeding unit 30 will be described below.

The cartridge tray unit 50 includes a tray 51 and cartridges PY, PM, PC, and PK. The tray 51 includes a tray handle 52. The cartridges PY, PM, PC, and PK are detachably attached to the tray 51. In the present exemplary embodiment, the cartridges PY, PM, PC, and PK can be detachably attached to the tray 51 independent of each other.

The cartridges PY, PM, PC, and PK contain yellow (Y), magenta (M), cyan (C), and black (K) toners (developers), respectively. The cartridges PY, PM, PC, and PK have the same configuration except in the colors of the contained toners. The configuration and operation of one of the cartridges PY, PM, PC, and PK will therefore be described, and a description of the others may be omitted. When the cartridges PY, PM, PC, and PK do not need to be distinguished, the cartridges PY, PM, PC, and PK may be referred to simply as cartridges P.

The cartridge tray unit 50 includes four photosensitive drums (image bearing members) 61, four charging rollers (charging members) 62, and four developing rollers (developer bearing members) 71. The rotation axis directions of the photosensitive drums 61, the rotation axis directions of the developing rollers 71, and the rotation axis directions of the charging rollers 62 are parallel to each other and the same as the Y direction.

The part of the cartridge tray unit 50 where K images are formed will be referred to as a K station (first station). The photosensitive drum 61 in the first station will be referred to as a first photosensitive drum, the developing roller 71 a first developing roller, and the charging roller 62 a first charging roller. The part of the cartridge tray unit 50 where C images are formed will be referred to as a C station (second station). The photosensitive drum 61 in the second station will be referred to as a second photosensitive drum, the developing roller 71 a second developing roller, and the charging roller 62 a second charging roller. The part of the cartridge tray unit 50 where M images are formed will be referred to as an M station (third station). The photosensitive drum 61 in the third station will be referred to as a third photosensitive drum, the developing roller 71 a third developing roller, and the charging roller 62 a third charging roller. The part of the cartridge tray unit 50 where Y images are formed will be referred to as a Y station (fourth station). The photosensitive drum 61 in the fourth station will be referred to as a fourth photosensitive drum, the developing roller 71 a fourth developing roller, and the charging roller 62 a fourth charging roller.

The photosensitive drums 61, the charging rollers 62, and the developing rollers 71 may be included in either the cartridges P or the tray 51. In the present exemplary embodiment, the cartridges P include the photosensitive drums 61, the charging rollers 62, and the developing rollers 71.

The transfer unit 40 includes a belt (intermediate transfer belt) 41, primary transfer rollers 42, a cleaning unit 43, a driving roller 46 for driving the belt 41, and a tension roller (roller to be driven) 47. The printer 1 according to the present exemplary embodiment includes an optical sensor 44 for detecting toner images transferred to the belt 41. In the present exemplary embodiment, the belt 41 is located under the photosensitive drums 61, and can be brought into contact with the photosensitive drums 61 to form primary transfer portions.

The printer 1 also includes a secondary transfer roller 45 that contacts the belt 41 to form a secondary transfer nip. The rotation axis directions of the primary transfer rollers 42, the rotation axis direction of the driving roller 46, the rotation axis direction of the tension roller 47, and the rotation axis direction of the secondary transfer roller 45 are parallel to each other and the same as the Y direction. A registration roller pair 4 is located on a sheet conveyance path, in front of the secondary transfer portion.

The fixing device 80 includes a fixing unit 81 and a discharge reversing unit 5. The fixing device 80 is configured to apply heat and pressure to a sheet S. In the present exemplary embodiment, the fixing unit 81 includes a heating unit (heating roller) 82 including a heater and a pressurization unit (pressure roller) 83. For example, the heater (heat source) may be a halogen lamp or a heater substrate on which a resistive heating element pattern is printed. The discharge reversing unit 5 includes a discharge roller pair 6, a reversing roller pair 8, and a switching member 84.

### Image Forming Operation

A series of operations (image forming operation) by which the printer 1 forms an image on a sheet S while conveying the sheet S will be described with reference to FIG. 1. The control unit 3 of the printer 1 starts the image forming operation based on an image signal received from an external host apparatus 400. Examples of the external host apparatus 400 include a personal computer, an image reader, and a facsimile.

In the image forming operation, the photosensitive drums 61 and the belt 41 initially start to be driven to rotate. A charging voltage is applied to the charging rollers 62, whereby the surfaces of the corresponding photosensitive drums 61 are charged. The scanner 2 irradiates the photosensitive drums 61 with laser corresponding to image information, whereby the surfaces of the photosensitive drums 61 are exposed. This forms electrostatic latent images corresponding to the image information on the surfaces of the photosensitive drums 61.

The developing rollers 71 bear the toners and supply the toners to the corresponding photosensitive drums 61. A developing voltage is applied to the developing rollers 71, and the electrostatic latent images formed on the photosensitive drums 61 are developed by the toners supplied from the developing rollers 71, whereby toner images are formed on the surfaces of the photosensitive drums 61. In the present exemplary embodiment, the developing rollers 71 develop the electrostatic latent images in contact with the photosensitive drums 61 (contact developing method). However, the developing rollers 71 may develop the electrostatic latent images with a gap between the developing rollers 71 and the photosensitive drums 61.

In the present exemplary embodiment, each developing roller 71 can move between a contact position where the developing roller 71 contacts the photosensitive drum 61 and a separated position where the developing roller 71 is separated from the photosensitive drum 61. Specifically, the state where the developing roller 71 is at the contact position and the state where the developing roller 71 is at the separated position are switched by a not-illustrated switching device included in the apparatus main body 1A. When the image forming operation is not being performed, the developing rollers 71 can thus be kept separated from the photosensitive drums 61.

In forming a full color image by the image forming operation, four color toner images are formed on the four photosensitive drums 61. The printer 1 can form a full color image with the photosensitive drums 61 corresponding to the cartridges PY, PM, PC, and PK in contact with the belt 41. The printer 1 can form a monochrome image with the developing roller 71 and the photosensitive drum 61 corresponding to the cartridge PK in contact with each other and the developing rollers 71 and the photosensitive drums 61 corresponding to the respective cartridges PY, PM, and PC separated from each other.

The toner images formed on the photosensitive drums 61 are transferred to the belt 41 by the primary transfer rollers 42, and conveyed toward the secondary transfer portion formed between the belt 41 and the secondary transfer roller 45.

Meanwhile, a sheet S is fed from the sheet feeding unit 30 toward the secondary transfer portion. Details of the feed operation will be described below.

The toner images are transferred from the belt 41 to the sheet S conveyed to the secondary transfer portion. Toner left untransferred to the sheet S is removed from the belt 41 by a cleaning blade (cleaning member) 43A included in the cleaning unit 43. The sheet S to which the toner images are transferred at the secondary transfer portion is conveyed toward the fixing device 80. In the fixing device 80, the sheet S is heated and pressurized by the fixing unit 81, whereby the toner images are fixed to the sheet S.

The sheet S past the fixing unit 81 is guided to a discharge path 12 or a two- sided path 11 by the switching member 84. In the case of one-sided printing, the sheet S is guided to the discharge path 12, discharged from the apparatus main body 1A by the discharge roller pair 6, and stacked on a discharge tray 7 located on top of the apparatus main body 1A. In the case of two-sided printing, the sheet S on the first side of which an image is formed through the secondary transfer portion and the fixing unit 81 is guided to the two-sided path 11, reversely conveyed (switched back) by the reversing roller pair 8, and conveyed toward the secondary transfer portion again. The sheet S then passes through the secondary transfer portion and the fixing unit 81 for the second time, whereby an image is formed on the second side. The sheet S is then discharged from the apparatus main body 1A by the discharge roller pair 6, and stacked on the discharge tray 7 located on top of the apparatus main body 1A.

### Sheet Feeding Unit

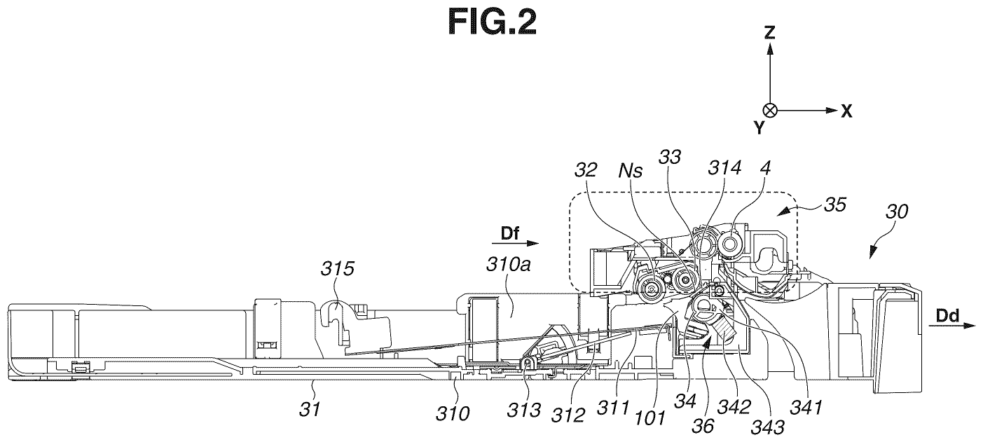

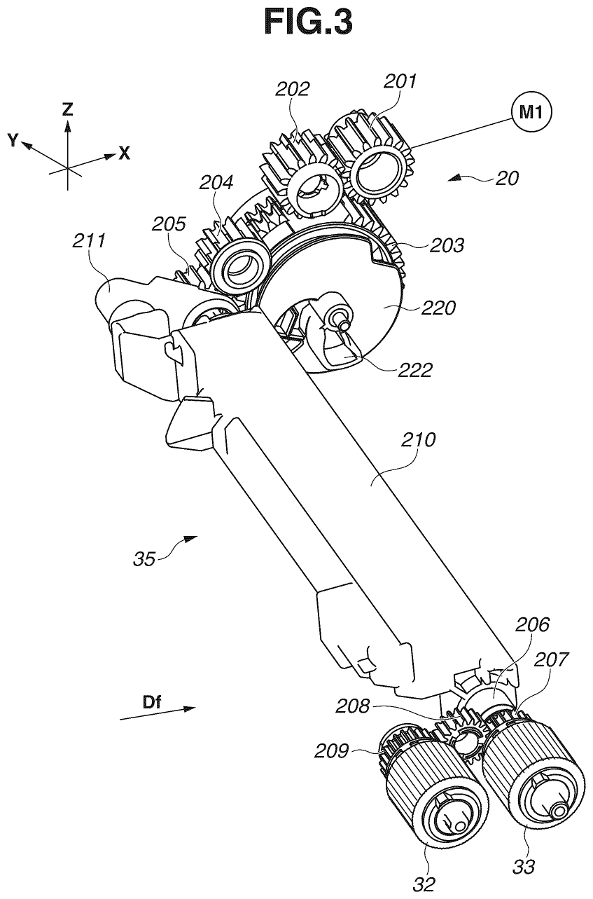

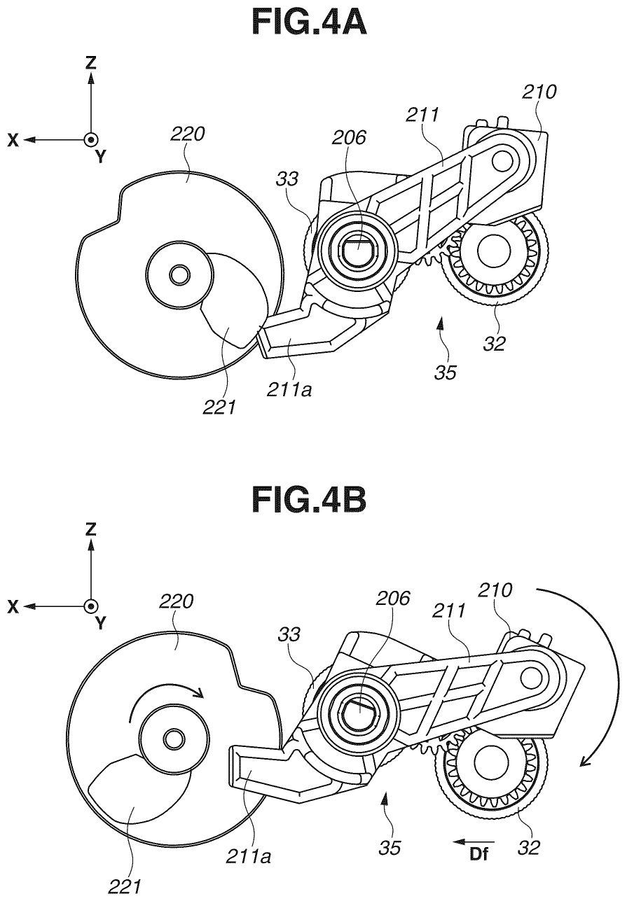

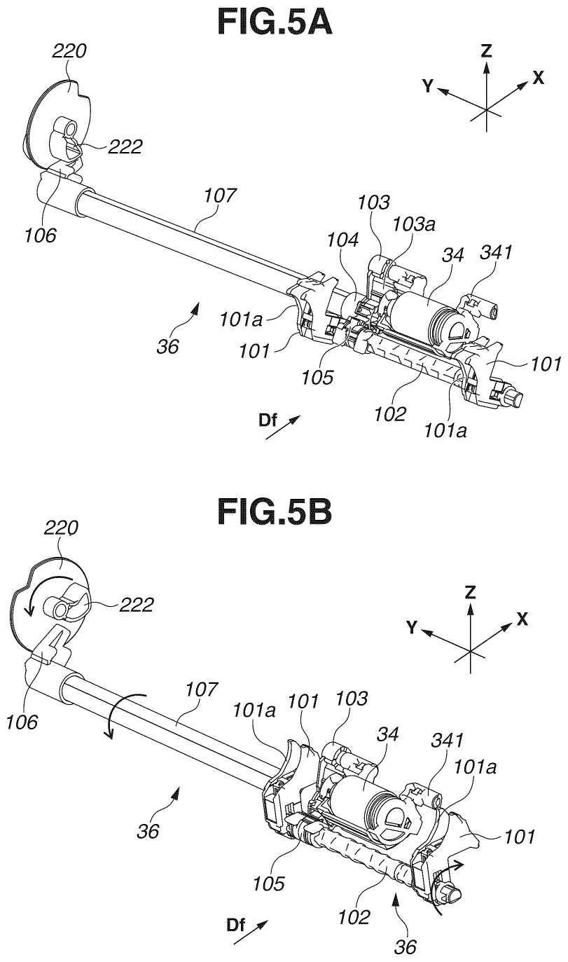

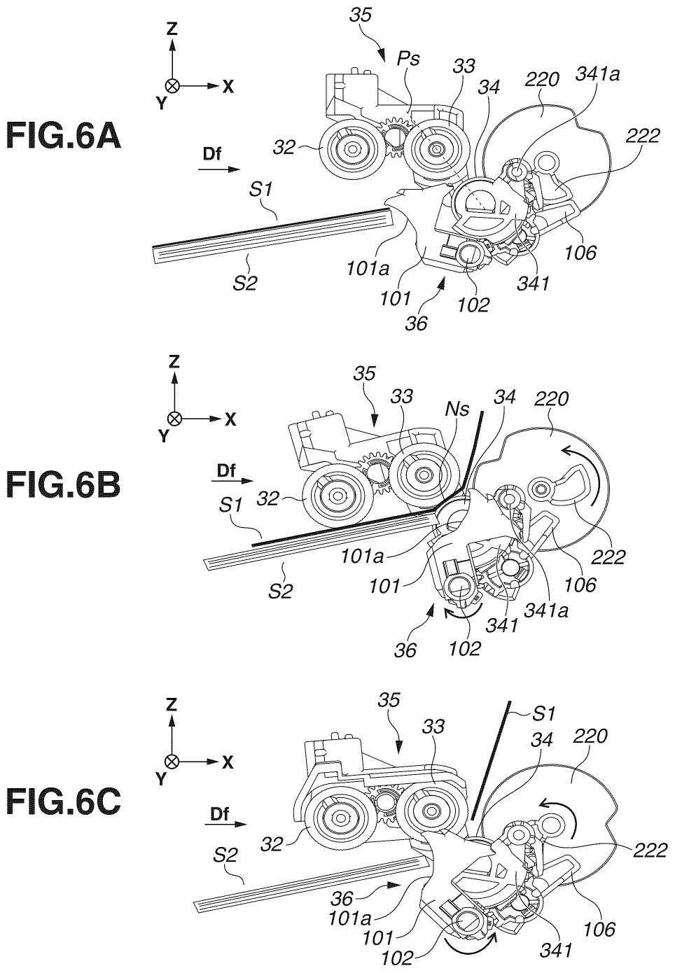

Next, a configuration of the sheet feeding unit 30 will be described with reference to FIGS. 2 to 6C. FIG. 2 is a sectional view of the entire sheet feeding unit 30. FIG. 3 is a perspective view of the feed unit 35. FIGS. 4A and 4B are diagrams illustrating operation of the feed unit 35. FIGS. 5A and 5B are diagrams illustrating operation of the separation unit 36 and a feed cam 220. FIGS. 6A to 6C are diagrams illustrating operation of the separation unit 36 and the feed unit 35.

As illustrated in FIGS. 2 to 6C, the sheet feeding unit 30 includes the sheet cassette 31 (cassette), the feed unit 35, a driving device 20, and the separation unit 36. In the present exemplary embodiment, the separation unit 36 is disposed on the sheet cassette 31. The feed unit 35 and the driving device 20 are disposed on the apparatus main body 1A.

### Sheet Cassette

As illustrated in FIG. 2, the sheet cassette 31 includes a cassette frame 310, a lift plate 311 (sheet support unit) swingably attached to the cassette frame 310, and a lift arm 312 that lifts the lift plate 311 up and down. An accommodation space 310a for accommodating sheets S is formed in the cassette frame 310.

The sheet cassette 31 is mounted on the apparatus main body 1A to be capable of being drawn out to the front side of the printer 1 (rightward in FIG. 1). In the present exemplary embodiment, the drawing direction Dd of the sheet cassette 31 is downstream in the sheet feeding direction Df (FIG. 2) of sheets S fed from the sheet cassette 31. In other words, the sheet cassette 31 (cassette) is configured to be drawn out from the apparatus main body 1A downstream in the sheet feeding direction Df. In the present exemplary embodiment, stoppers 101 and the separation roller 34 located downstream of the accommodation space 310a of the sheet cassette 31 in the sheet feeding direction Df are disposed on the sheet cassette 31. In other words, the sheet cassette 31 includes the stoppers 101 and the separation roller 34. When the sheet cassette 31 is moved relative to the apparatus main body 1A, the stoppers 101 and the separation roller 34 are also moved relative to the apparatus main body 1A. When the sheet cassette 31 is drawn out downstream in the sheet feeding direction Df, the sheet cassette 31 therefore does not interfere with the stoppers 101 or the separation roller 34.

With the sheet cassette 31 mounted on the apparatus main body 1A, the lift arm 312 is connected to a driving source disposed on the apparatus main body 1A. The lift arm 312 is rotated about a shaft 313 by the driving force of the driving source, whereby the lift plate 311 can be lifted up to a position where the feed unit 35 can feed the topmost sheet S in the sheet cassette 31.

The sheet cassette 31 is equipped with a feed guide 314. The feed guide 314 is a guide member for guiding the lower surface of the sheet S between a pickup roller 32 and a feed roller 33.

### Feed Unit

As illustrated in FIGS. 2 and 3, the feed unit 35 includes the pickup roller 32, the feed roller 33, a feed shaft 206, a roller driving gear 205, a feed gear 207, an idler gear 208, and a pickup gear 209. The feed unit 35 also includes a roller lifting member 210 and a roller lifting link 211.

The pickup roller 32 is located above the accommodation space 310a for accommodating sheets S in the sheet cassette 31. The pickup roller 32 rotates in contact with the topmost sheet S in the sheet cassette 31 and thereby feeds the sheet S in the sheet feeding direction Df. The feed roller 33 is a feed member for feeding the sheet S accommodated in the sheet cassette 31 in the sheet feeding direction Df. The feed roller 33 of the present exemplary embodiment is located downstream of the pickup roller 32 in the sheet feeding direction Df, and conveys the sheet S received from the pickup roller 32.

The feed gear 207 is attached to an end of the feed shaft 206 that is a roller shaft supporting the feed roller 33. The roller driving gear 205 is attached to the other end of the feed shaft 206. The roller driving gear 205 is an input unit to which driving force for driving the feed roller 33 and the pickup roller 32 to rotate is input from the driving device 20. The feed roller 33, the feed gear 207, and the roller driving gear 205 can rotate integrally about the center axis of the feed shaft 206. In other words, the driving force input to the roller driving gear 205 is transmitted to the feed roller 33 via the feed shaft 206.

The pickup gear 209 is attached to a roller shaft supporting the pickup roller 32, and rotates integrally with the pickup roller 32. The pickup gear 209 is connected to the feed gear 207 via the idler gear 208. In other words, part of the driving force input to the roller driving gear 205 is transmitted to the pickup roller 32 via the feed shaft 206, the feed gear 207, the idler gear 208, and the pickup gear 209.

One-way clutches may be disposed between the feed gear 207 and the feed roller 33 and between the pickup gear 209 and the pickup roller 32. The one-way clutches allow the feed roller 33 and the pickup roller 32 to be pulled and rotated by the sheet S moving in the sheet feeding direction Df even in a state where the rotation of a motor M1 to be described below is stopped, for example.

The pickup roller 32, the feed roller 33, the pickup gear 209, the idler gear 208, and the feed gear 207 are attached to the roller lifting member 210 via a not-illustrated holder. The roller lifting member 210 is configured to be swingable (capable of being lifted up and down) about the feed shaft 206. In other words, the pickup roller 32 can be swung (lifted up and down) about the feed shaft 206. The pickup roller 32 can be moved to a feed position where the pickup roller 32 contacts the topmost sheet S of the sheet bundle on the lift plate 311 and a standby position where the pickup roller 32 is separated upward from the topmost sheet S.

The roller lifting member 210 is biased in a direction of lowering the pickup roller 32 by the biasing force of a not-illustrated biasing member. An example of the biasing member is a spring member engaged at one end with a spring hook of the apparatus main body 1A and at the other end with the roller lifting member 210.

The roller lifting link 211 is configured to swing about the feed shaft 206 integrally with the roller lifting member 210. The roller lifting link 211 includes a cam contact portion 211a with which a roller lifting cam portion 221 (FIG. 4A) of the feed cam 220 to be described below comes into contact. The roller lifting link 211 is a unit to be driven (drive input unit) that receives the driving force for lifting the pickup roller 32 up and down from the driving device 20.

### Driving Device

The driving device 20 is a mechanism for transmitting the driving force generated by the motor M1 serving as a driving source to the feed unit 35. As illustrated in FIG. 3, the driving device 20 includes the motor M1 (driving source), a first driving gear 201, a second driving gear 202, a partially toothed gear 203, the feed cam 220, and an idler gear 204.

The first driving gear 201 is connected to the motor M1 and rotated by the driving force of the motor M1.

The second driving gear 202 meshes with the first driving gear 201. The partially toothed gear 203 can mesh with the second driving gear 202 and the idler gear 204. The idler gear 204 meshes with the roller driving gear 205 of the feed unit 35.

The feed cam 220 is attached to a side surface of the partially toothed gear 203 and can rotate with the partially toothed gear 203. The feed cam 220 includes a disk-shaped base portion 220a, the roller lifting cam portion 221 (FIG. 4A) serving as a first cam, and a separation cam portion 222 serving as a second cam. The roller lifting cam portion 221 and the separation cam portion 222 are disposed on respective opposite sides of the base portion 220a. The feed cam 220 including the separation cam portion 222 is an example of a driving member that is disposed on the apparatus main body 1A and connected to the motor M1 (driving source).

The partially toothed gear 203 is configured to be switchable between a rotation-restricted state and rotation-allowed state by an actuator such as a solenoid, and configured to mesh selectively with the second driving gear 202. More specifically, when the partially toothed gear 203 is put in a predetermined rotational phase by the solenoid for rotation restriction, a no-tooth region of the partially toothed gear 203 is opposed to the second driving gear 202, whereby the second driving gear 202 and the partially toothed gear 203 are unmeshed. When the rotation restriction on the partially toothed gear 203 by the solenoid is lifted, the partially toothed gear 203 is rotated by a not-illustrated biasing unit up to a rotational phase where the teeth of the partially toothed gear 203 mesh with the second driving gear 202. The second driving gear 202 and the partially toothed gear 203 can thus mesh with each other.

### Separation Unit

As illustrated in FIGS. 5A, 5B, and 6A to 6C, the separation unit 36 includes the separation roller 34, a roller holder 341, a nip pressure spring 342 (FIG. 2), and a separation frame 343 (FIG. 2). The separation unit 36 also includes the stoppers 101, a stopper shaft 102, a roller holder gear 103, a separation gear 104, a stopper gear 105, a separation lever 106, and a separation shaft 107.

The separation roller 34 is located opposite to the feed roller 33, and held by the roller holder 341 via a torque limiter. The roller holder 341 is a holder member that holds the separation roller 34 serving as a separation member. A separation nip Ns is formed as a nip portion where the feed roller 33 and the separation roller 34 contact each other. The torque limiter allows the separation roller 34 to rotate when torque higher than or equal to a predetermined value acts on the separation roller 34. The separation roller 34 is an example of a separation member that forms a nip portion with the feed roller 33 (feed member), allows the topmost sheet in contact with the feed roller 33 to pass through the nip portion, and prevents sheets other than the topmost sheet S to pass through the nip portion. In other words, when a plurality of sheets S is conveyed to the separation nip Ns, the topmost sheet S in the plurality of sheets S may be referred to as a first sheet, and the sheets S other than the topmost sheet S may be referred to as at least one second sheet. The at least one second sheet that the separation member separates from the first sheet can be one sheet or more than one sheet.

The separation roller 34 according to the present exemplary embodiment is an example of the separation member, and the separation member is not limited thereto. A pad-shaped elastic member (separation pad) that contacts the feed roller 33 may be used as the separation member. A roller (retard roller) to which driving force in a retard direction is input via a torque limiter may be used as the separation member. The retard direction refers to a rotation direction in which the moving direction of the roller periphery at the separation nip Ns is opposite to the sheet feeding direction Df. In other words, the “separation member” may be any member that forms the separation nip Ns with the feed roller 33 and separates a plurality of sheets S by applying frictional force to the sheets S at the separation nip Ns so that the sheets S can pass through the separation nip Ns one by one.

The roller holder 341 and the nip pressure spring 342 are attached to the separation frame 343. The nip pressure spring 342 biases the roller holder 341 so that the separation roller 34 is pressed against the feed roller 33. In the present exemplary embodiment, the separation nip Ns is formed by the separation roller 34 being brought into contact with the feed roller 33 by the biasing force of the nip pressure spring 342.

At least a part of the feed guide 314 of the sheet cassette 31 described above is configured to guide the leading edges of the sheets S fed by the pickup roller 32 to the separation nip Ns.

The roller holder gear 103 and the roller holder 341 can rotate about a common rotation axis. The roller holder gear 103 meshes with the separation gear 104. The roller holder gear 103 has an engagement portion 103a (FIG. 5A) to engage with the roller holder 341. The engagement portion 103a presses the roller holder 341, whereby the roller holder 341 is rotated integrally with the roller holder gear 103. The rotation of the roller holder 341 can move the separation roller 34 to a contact position where the separation roller 34 comes into contact with the feed roller 33 and a separated position where the separation roller 34 is separated from the feed roller 33.

The separation shaft 107 extends in a direction parallel to the rotation axis of the separation roller 34 (Y direction). The separation lever 106 is attached to one end of the separation shaft 107, and the separation gear 104 is attached to the other end of the separation shaft 107. The separation shaft 107 is rotatably held by the separation frame 343. The separation lever 106 can come into contact with the separation cam portion 222 of the feed cam 220.

With the separation lever 106 pressed by the separation cam portion 222, the separation lever 106, the separation shaft 107, and the separation gear 104 rotate integrally about the center axis of the separation shaft 107. The separation lever 106 is an example of a member to be driven (drive input unit) that receives the driving force from the driving device 20 of the apparatus main body 1A. The separation lever 106 that is the member to be driven of the present exemplary embodiment is configured as a cam follower that moves when pressed by the feed cam 220 (cam).

The stoppers 101 are an example of a return member that pushes back the sheets S other than the topmost sheet S in contact with the feed roller 33 (feed member) upstream of the separation nip Ns (nip portion) in the sheet feeding direction Df. In the present exemplary embodiment, the stoppers 101 are disposed on the sheet cassette 31 as a part of the separation unit 36.

The stoppers 101 are attached to the stopper shaft 102 extending in the direction parallel to the rotation axis of the separation roller 34 (Y direction). The stoppers 101 have contact surfaces 101a that can come into contact with the leading edges of sheets S. In the present exemplary embodiment, one stopper 101 is located on each side of the separation roller 34 in the Y direction. The direction in which the contact surfaces 101a push the sheets S is desirably substantially parallel to the sheets S. While the stoppers 101 move, the direction in which the contact surfaces 101a push the sheets S are therefore desirably substantially parallel to the sheets S. To keep the direction in which the contact surfaces 101a push the sheets S within a predetermined range while the stoppers 101 move, the contact surfaces 101a may include at least one of a curved surface, a plurality of flat surfaces with different angles, or a plurality of curved surfaces with different curvatures.

The stopper gear 105 is also attached to the stopper shaft 102. The stopper gear 105 meshes with the separation gear 104. The stopper shaft 102 is rotatably held by the separation frame 343.

The separation shaft 107, the stopper shaft 102, the roller holder gear 103, the separation gear 104, and the stopper gear 105 function as a transmission mechanism for transmitting the driving force that the separation lever 106 (member to be driven) receives from the feed cam 220 (driving member) of the apparatus main body 1A. This transmission mechanism transmits the driving force received by the separation lever 106 (member to be driven) to the roller holder 341 (holder member) and the stoppers 101 (return members). As will be described below, with the sheet cassette 31 mounted on the apparatus main body 1A, this transmission mechanism moves the roller holder 341 in a manner interlocked with the movement of the stoppers 101 from a restriction position P1 (first position) to a non-restriction position P2 (second position). In doing so, the transmission mechanism moves the roller holder 341 so that the separation roller 34 comes into contact with the feed roller 33.

The transmission mechanism according to the present exemplary embodiment includes the separation shaft 107 serving as a first shaft unit to which the separation lever 106 (member to be driven) is attached and the stopper shaft 102 serving as a second shaft unit to which the stoppers 101 (return members) are attached. The transmission mechanism according to the present exemplary embodiment also includes an engagement portion 103a to be engaged with the roller holder 341 (holder member), and a gear train (103, 104, and 105) that transmits the driving force from the separation shaft 107 (first shaft unit) to the stopper shaft 102 (second shaft unit) and the engagement portion 103a.

With the sheet cassette 31 mounted on the apparatus main body 1A, the stoppers 101 can be moved to the restriction position (first position, return position) illustrated in FIGS. 5A and 6A and the non-restriction position (second position, allowing position, passing position) illustrated in FIGS. 5B and 6B. The restriction position is a position where at least a part of the contact surfaces 101a of the stoppers 101 lies upstream of a separation nip position Ps in the sheet feeding direction Df. The separation nip position Ps refers to the position where the distance between the peripheral surface of the feed roller 33 and the peripheral surface of the separation roller 34 is smallest in the sheet feeding direction Df. In other words, the restriction position is the position where the stoppers 101 are when the stoppers 101 push back sheets S upstream of the separation nip Ns (FIG. 6B) in the sheet feeding direction Df. The non-restriction position is the position where the stoppers 101 are when the contact surfaces 101a are retracted downstream of the separation nip Ns in the sheet feeding direction Df. More specifically, the non-restriction position is the position where the stoppers 101 allow passage of the sheets S conveyed by the feed roller 33 (feed member). In other words, when the stoppers 101 are at the non-restriction position, the sheets S conveyed by the pickup roller 32 can reach the separation nip Ns.

As will be described below, the stoppers 101 and the separation roller 34 move in a manner interlocked with the operation of the feed unit 35 during the process of the sheet feed operation. As will be described below, the stoppers 101 can also be moved to a retracted position (third position) different from the restriction and non-restriction positions depending on the insertion and removal of the sheet cassette 31.

### Feed Operation

A series of operations (feed operation) by which the sheet feeding unit 30 feeds sheets S one by one during the image forming operation will be described. The state before the start of the feed operation will initially be described with reference to FIGS. 4A, 5A, and 6A.

In the state before the start of the feed operation, as illustrated in FIG. 4A, the roller lifting cam portion 221 of the feed cam 220 is in contact with the roller lifting link 211. The contact between the roller lifting cam portion 221 and the roller lifting link 211 holds the feed unit 35 in a state where the pickup roller 32 is at the standby position where the pickup roller 32 is separated upward from the topmost sheet S (hereinafter, may be referred to as topmost sheet S1) in the sheet cassette 31 (FIG. 6A).

In the state before the start of the feed operation, as illustrated in FIGS. 5A and 6A, the separation cam portion 222 of the feed cam 220 is in contact with the separation lever 106. The contact between the separation cam portion 222 and the separation lever 106 maintains the roller holder gear 103 pushing down the roller holder 341 against the biasing force of the nip pressure spring 342, and the separation roller 34 is held at the separated position.

In the state before the start of the feed operation, the contact between the separation cam portion 222 and the separation lever 106 holds the stopper gear 105 at a predetermined rotational phase so that the stoppers 101 are located at the restriction position.

When the feed operation is started, the rotation restriction on the partially toothed gear 203 (FIG. 3) by the solenoid is lifted, and the driving device 20 starts drive transmission. With the drive transmission of the driving device 20 started, the feed cam 220 starts to rotate with the partially toothed gear 203.

The feed cam 220 rotates in a predetermined rotation direction as illustrated in FIG. 4B (clockwise in the diagram). The rotation of the feed cam 220 starts to disengage the roller lifting cam portion 221 from the cam contact portion 211a of the roller lifting link 211. The roller lifting member 210 then swings clockwise in the diagram about the feed shaft 206 along with the roller lifting link 211, whereby the pickup roller 32 is lowered from the standby position to the feed position. The rotation of the partially toothed gear 203 also inputs driving force to the roller driving gear 205 (FIG. 3), whereby the feed roller 33 and the pickup roller 32 are driven to rotate. Since the pickup roller 32 and the feed roller 33 rotate with the pickup roller 32 at the feed position contacting the topmost sheet S1 in the sheet cassette 31, the topmost sheet S1 is fed in the sheet feeding direction Df.

Once the feed operation is started, as illustrated in FIGS. 5B and 6B, the separation cam portion 222 of the feed cam 220 disengages from the separation lever 106. The disengagement of the separation lever 106 from the separation cam portion 222 lifts the rotation restriction on the separation shaft 107, and the rotation restriction on the roller holder 341 by the meshing between the separation gear 104 and the roller holder gear 103 is also lifted. This allows the roller holder 341 to rotate about the rotation shaft 341a due to the biasing force of the nip pressure spring 342 (FIG. 2) in the direction where the separation roller 34 approaches the feed roller 33 (clockwise in FIG. 5B). The rotation of the roller holder 341 moves the separation roller 34 from the separated position to the contact position, whereby the separation nip Ns is formed. Meanwhile, the biasing force of the nip pressure spring 342 is transmitted to the separation shaft 107 via the roller holder 341, the roller holder gear 103, and the separation gear 104, and the separation shaft 107 rotates. This moves the separation lever 106 along the cam surface of the separation cam portion 222. When the separation roller 34 reaches the contact position, the rotation of the separation shaft 107 and the separation lever 106 stops.

Once the feed operation is started, the biasing force of the nip pressure spring 342 rotates the separation shaft 107, and the stopper gear 105 is rotated by the separation gear 104 on the separation shaft 107. The rotation of the stopper gear 105 moves the stoppers 101 in the direction from the restriction position toward the non-restriction position about the stopper shaft 102 (clockwise in FIG. 5B). The stoppers 101 are configured to move from the restriction position to the non-restriction position while the separation roller 34 moves from the separated position to the contact position.

The topmost sheet S1 started to be fed by the pickup roller 32 is conveyed through the separation nip Ns. Here, a sheet or sheets S (hereinafter, may be referred to as sheet(s) S2) stacked under the topmost sheet S1 may enter the separation nip Ns along with the topmost sheet S1 due to friction between the sheets. However, the separation roller 34 gives the sheet(s) S2 other than the topmost sheet S1 a frictional force in the direction opposite to the sheet feeding direction Df at the separation nip Ns, whereby the sheet(s) S2 other than the topmost sheet S1 is/are prevented from passing through the separation nip Ns. In other words, when at least one second sheet is conveyed to the separation nip Ns along with the topmost sheet S1, the separation roller 34 prevents the at least one second sheet from passing through the separation nip Ns. On the other hand, when only the topmost sheet S1 enters the separation nip Ns singly, the separation roller 34 rotates to follow the topmost sheet S1 and allows the topmost sheet S1 to pass through the separation nip Ns.

When the feed cam 220 rotates further, the roller lifting cam portion 221 of the feed cam 220 comes into contact with the roller lifting link 211 again (FIG. 4A). The contact between the roller lifting cam portion 221 and the roller lifting link 211 holds the feed unit 35 in a state where the pickup roller 32 is at the standby position (FIG. 6A).

When the feed cam 220 rotates up to a predetermined angle from the start of the feed operation, as illustrated in FIG. 6C, the separation cam portion 222 of the feed cam 220 comes into contact with the separation lever 106 again. The separation cam portion 222 presses the separation lever 106 to rotate the separation shaft 107. As the separation shaft 107 rotates, the separation gear 104 rotates the roller holder gear 103, and the roller holder gear 103 pushes down the roller holder 341 against the biasing force of the nip pressure spring 342. The separation roller 34 is thereby moved from the contact position toward the separated position and separated from the feed roller 33.

When the feed cam 220 rotates up to the predetermined angle from the start of the feed operation, the separation gear 104 rotates the stopper gear 105 along with the rotation of the separation shaft 107. As the stopper gear 105 rotates, the stoppers 101 swing about the stopper shaft 102 counterclockwise in FIG. 6C. In other words, the stoppers 101 swing from the non-restriction position toward the restriction position.

In the process of the stoppers 101 moving from the non-restriction position to the restriction position, the contact surfaces 101a of the stoppers 101 come into contact with the leading edge(s) of the sheet(s) S2 brought together to near the separation nip Ns in feeding the topmost sheet S1. The stoppers 101 then push back the leading edge(s) of the sheet(s) S2 to a position upstream of the separation nip Ns while moving to the restriction position (FIG. 6A).

Once the partially toothed gear 203 completes one rotation from the start of the feed operation, the rotation of the partially toothed gear 203 is restricted by the solenoid again. The drive transmission of the driving device 20 is thereby interrupted, and the feed unit 35 and the separation unit 36 return to the state before the start of the feed operation, illustrated in FIGS. 4A, 5A, and 6A. This completes the feed operation of a single sheet S.

In feeding a plurality of sheets S in succession, the foregoing feed operation is repeated sheet by sheet. Even when the feed operation is repeated, the stoppers 101 repeat the operation of pushing back the sheet(s) S2 other than the topmost sheet S1 to be fed by the current feed operation upstream of the separation nip Ns sheet by sheet. This can reliably prevent multiple sheet feeding compared to the case where the stoppers 101 are not used.

As described above, with the sheet cassette 31 mounted on the apparatus main body 1A, the feed cam 220 (driving member) of the apparatus main body 1A engages with the separation lever 106 (member to be driven) of the sheet cassette 31 to transmit the driving force of the motor M1 (driving force). The stoppers 101 (return members) is moved between the restriction position (first position) and the non-restriction position (second position) by such drive transmission.

### Operation During Insertion and Removal of Cassette

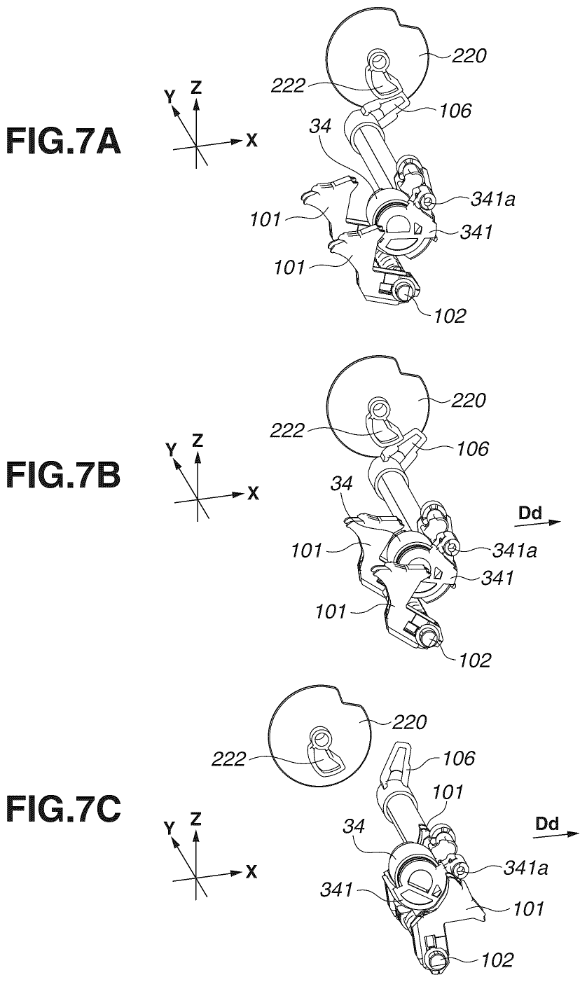

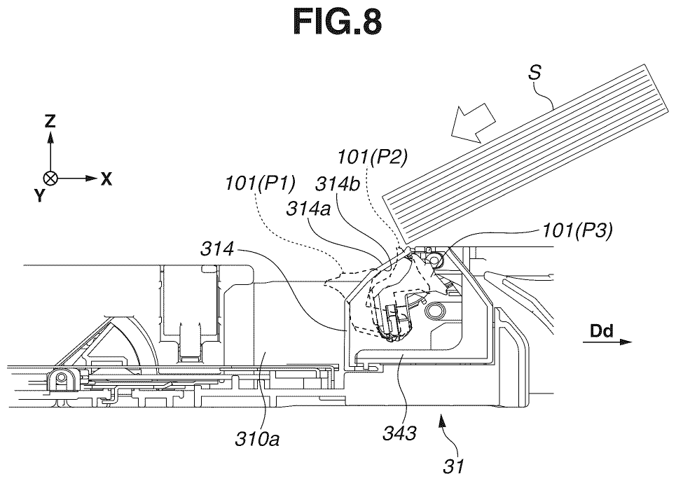

Next, the operation of the separation unit 36 when the sheet cassette 31 is drawn out from and mounted on the apparatus main body 1A (hereinafter, referred to as insertion and removal) will be described with reference to FIGS. 7A to 7C and 8. FIG. 7A to 7C are perspective views illustrating the operation of the separation unit 36 when the sheet cassette 31 is drawn out from the apparatus main body 1A. FIG. 8 is a sectional view illustrating how the sheet cassette 31 is replenished with sheets S.

FIG. 7A illustrates a state where the sheet cassette 31 is mounted at a predetermined mounting position in the apparatus main body 1A (position where the sheet feeding unit 30 can feed sheets S from the sheet cassette 31).

FIG. 7B illustrates a state where the sheet cassette 31 is drawn out several millimeters or so from the mounting position in the drawing direction Dd. FIG. 7C illustrates a state where the sheet cassette 31 is further drawn out from the state of FIG. 7B in the drawing direction Dd.

As described above, the feed unit 35 and the driving device 20 are disposed on the apparatus main body 1A, and the separation unit 36 is disposed on the sheet cassette 31. When the sheet cassette 31 is drawn out from the apparatus main body 1A, as will be described in detail below, the separation cam portion 222 of the feed cam 220 of the driving device 20 is therefore separated from the separation lever 106 of the separation unit 36. In other words, when the sheet cassette 31 is drawn out from the apparatus main body 1A, the feed cam 220 (driving member) of the apparatus main body 1A is separated from the separation lever 106 (member to be driven) of the sheet cassette 31.

As illustrated in FIGS. 7A and 7B, when the sheet cassette 31 starts to move from the mounting position in the drawing direction Dd, the separation lever 106 moves in the drawing direction Dd relative to the separation cam portion 222. Since the separation lever 106 is gradually released from the separation cam portion 222, the rotation restriction on the separation shaft 107 is lifted and the rotation restriction on the roller holder 341 due to the meshing between the separation gear 104 and the roller holder gear 103 is lifted as well. The biasing force of the nip pressure spring 342 then rotates the roller holder 341 in the direction where the separation roller 34 approaches the feed roller 33 (clockwise in the diagrams). Since the biasing force of the nip pressure spring 342 also rotates the separation shaft 107, the stopper gear 105 is rotated by the separation gear 104 on the separation shaft 107, and the stoppers 101 move from the restriction position toward the non-restriction position (clockwise in FIG. 7B).

In other words, when the sheet cassette 31 starts to move from the mounting position in the drawing direction Dd, the separation roller 34 starts to move from the separated position to the contact position and the stoppers 101 start move from the restriction position to the non-restriction position, as with the beginning of the feed operation.

Unlike the feed operation, when the sheet cassette 31 is drawing out from the apparatus main body 1A, the roller holder 341 does not stop at the position where the separation roller 34 comes into contact with the feed roller 33. The roller holder 341 rotates clockwise in the diagram beyond the position where the separation roller 34 comes into contact with the feed roller 33 during the feed operation, and stops upon abutting against the feed guide 314. Specifically, the stop position of the roller holder 341 when the sheet cassette 31 is drawn out from the apparatus main body 1A is where a part of the roller holder 341 abuts against a surface 314b (lower surface; see FIG. 8) of the feed guide 314 opposite to the guide surface 314a (upper surface).

While the roller holder 341 rotates clockwise in the diagram beyond the position where the separation roller 34 comes into contact with the feed roller 33 during the feed operation, the stoppers 101 also rotate clockwise in the diagram. As illustrated in FIGS. 7C and 8, a retracted position P3 (solid line) that is the position of the stoppers 101 with the sheet cassette 31 drawn out from the apparatus main body 1A thus refers to where the stoppers 101 have swung from the restriction position P1 beyond the non-restriction position P2. More specifically, with the sheet cassette 31 drawn out from the apparatus main body 1A, the stoppers 101 (return members) are located at the retracted position P3 (third position) downstream of the non-restriction position P2 in the moving direction from the restriction position P1 (first position) toward the non-restriction position P2 (second position).

In other words, the rotation angle of the roller holder 341 about the rotation shaft 341a when the sheet cassette 31 is drawn out from the apparatus main body 1A is greater than that of the roller holder 341 about the rotation shaft 341a during the feed operation. Moreover, the rotation angle of the stoppers 101 about the stopper shaft 102 when the sheet cassette 31 is drawn out from the apparatus main body 1A is greater than that of the stoppers 101 about the stopper shaft 102 during the feed operation.

As described above, with the sheet cassette 31 drawn out from the apparatus main body 1A, the stoppers 101 are located at the retracted position P3 further retracted from the non-restriction position P2 for allowing sheets S to pass during the feed operation. This makes the stoppers 101 less likely to interfere with the sheet replenishment work for the sheet cassette 31 in the state where the sheet cassette 31 is drawn out from the apparatus main body 1A, and can improve the workability.

In the present exemplary embodiment, the stoppers 101 (return members) are described to be located at the retracted position P3 (third position) by the biasing force of the nip pressure spring 342 serving as the biasing member when the sheet cassette 31 is drawn out and the feed cam 220 (driving member) and the separation lever 106 (member to be driven) are separated. Moreover, in the present exemplary embodiment, the nip pressure spring 342 not only biases the stoppers 101 but also serves as a spring member for pressing the separation roller 34 against the feed roller 33 to form the separation nip Ns. This can reduce the parts count. However, the biasing member is not limited thereto. For example, a spring member for biasing the stoppers 101 toward the retracted position P3 may be disposed aside from the nip pressure spring 342.

As illustrated in FIG. 8, the retracted position P3 of the stoppers 101 is desirably a position further retracted from the feed guide 314 that is the guide member for guiding the bottom surface of the sheets S upstream of the separation roller 34 in the sheet feeding direction Df. Specifically, when the stoppers 101 are at the retracted position P3, the stoppers 101 are desirably located entirely below the guide surface 314a (upper surface) of the feed guide 314 as viewed in the rotation axis direction of the feed roller 33 (Y direction). In other words, with the return members located at the retracted position P3 (third position), the stoppers 101 (return members) are desirably located entirely below the top surface (guide surface 314a) of the guide member as viewed in the rotation axis direction of the feed roller 33 (feed member).

This can prevent sheets S from catching on the stoppers 101 when the user sets the sheets S into the accommodation space 310a of the sheet cassette 31 along the guide surface 314a, for example. Moreover, even when the user sets the sheets S in different directions, the user can be prevented from inadvertently touching the stoppers 101, and the separation unit 36 can be prevented from being damaged.

In the present exemplary embodiment, the sheet cassette 31 is drawn out from the apparatus main body 1A downstream in the sheet feeding direction Df. The user is thus expected to access the sheet cassette 31 mostly from above the sheet cassette 31 and downstream in the sheet feeding direction Df. In such a case, when the sheets S are set obliquely downward along the guide surface 314a of the feed guide 314, the sheets S can be prevented from catching on the stoppers 101. Alternatively, the user may set the sheets S into the accommodation space 310a of the sheet cassette 31 in a state where a part of the sheet cassette 31 including the upstream end of the cassette frame 310 in the sheet feeding direction Df still remains inside the apparatus main body 1A.

In mounting the sheet cassette 31 drawn out of the apparatus main body 1A onto the apparatus main body 1A, the separation unit 36 operates in order reverse to during the foregoing withdrawal (in order of FIGS. 7C, 7B, and 7A).

More specifically, as illustrated in FIG. 7C, before the separation lever 106 comes into contact with the separation cam portion 222, the stoppers 101 are located at the retracted position P3 with the roller holder 341 in contact with the surface 314b of the feed guide 314.

As the sheet cassette 31 is inserted into the apparatus main body 1A, the separation lever 106 comes into contact with the separation cam portion 222 as illustrated in FIG. 7B. The separation lever 106 is then pressed by the separation cam portion 222, and the separation shaft 107 rotates clockwise in the diagram. The meshing between the separation gear 104 and the roller holder gear 103 rotates the roller holder 341 in the direction where the separation roller 34 gets away from the feed roller 33 (counterclockwise in the diagram) against the biasing force of the nip pressure spring 342. The roller holder 341 is thereby separated from the feed guide 314. As the separation shaft 107 rotates, the stopper gear 105 is rotated by the separation gear 104 on the separation shaft 107, and the stoppers 101 move from the retracted position P3 toward the non-restriction position P2 and the restriction position P1 (counterclockwise in FIGS. 7B and 8).

When the sheet cassette 31 is inserted further and reaches the mounting position, as illustrated in FIG. 7A, the separation unit 36 returns to the state before the start of the feed operation. Specifically, the roller holder 341 is positioned with the separation roller 34 at the contact position, whereby the stoppers 101 are located at the restriction position P1 (FIG. 8). When the sheet cassette 31 drawn out of the apparatus main body 1A is thus inserted into the apparatus main body 1A, the feed cam 220 (driving member) comes into contact with the separation lever 106 (member to be driven). The stoppers 101 (return members) are thereby moved from the retracted position P3 (third position) to the restriction position P1 (first position).

### Summary of Present Exemplary Embodiment

As described above, according to the configuration of the present exemplary embodiment, a new form of sheet feeding apparatus and image forming apparatus where the stoppers 101 (return members) are disposed on the sheet cassette 31 rather than on the apparatus main body 1A can be provided.

According to the present exemplary embodiment, in the state where the sheet cassette 31 is drawn out from the apparatus main body 1A, the stoppers 101 (return members) are located at the retracted position P3 (third position) that is further retracted from the non-restriction position P2. The user's hands and sheets S are thus prevented from touching the stoppers 101 in replenishing the sheet cassette 31 with the sheets S or taking out the sheets S. This enables smooth work without damaging the sheets S.

With the sheet cassette 31 mounted on the apparatus main body 1A, the stoppers 101 move between the restriction position P1 (first position) and the non-restriction position P2 (second position) that is closer to the restriction position P1 than the retracted position P3 (third position) is. The amount of movement of the stoppers 101 in the feed operation is thus smaller than that of the stoppers 101 when the sheet cassette 31 is inserted into and removed from the apparatus main body 1A. This can improve the throughput (number of sheets fed per unit time) of the sheet feeding unit 30, and enables the printer 1 to accommodate higher speeds.

Next, a second exemplary embodiment will be described. The second exemplary embodiment differs from the first exemplary embodiment in that the separation unit is driven by using a driving source independent of the motor M1 (FIG. 3) of the first exemplary embodiment. Hereinafter, elements denoted by reference numerals common with the first exemplary embodiment shall have basically the same configuration and operation as those described in the first exemplary embodiment unless otherwise specified. Differences from the first exemplary embodiment will mainly be described.

### Separation Unit

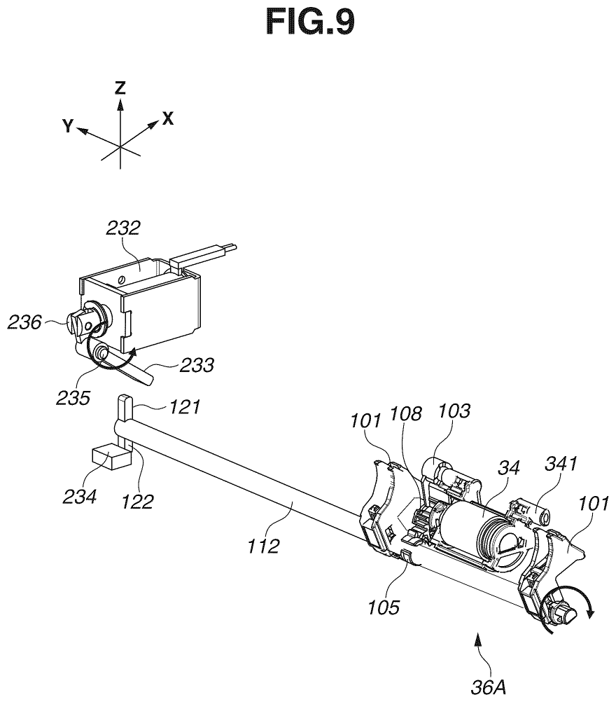

FIG. 9 is a perspective view illustrating a configuration of a separation unit 36A according to the second exemplary embodiment. The separation unit 36A includes a separation roller 34, a roller holder 341, a nip pressure spring 342 (FIG. 2), and a separation frame 343 (FIG. 2). The separation unit 36A also includes stoppers 101, a stopper shaft 112, a roller holder gear 103, a stopper gear 105, an idler gear 108, a separation lever 121, and a rotation restriction lever 122.

In the second exemplary embodiment, the apparatus main body 1A includes a solenoid unit (232, 233, and 235) including a solenoid 232 serving as a driving source, and an abutting unit 234. The solenoid unit includes the solenoid 232, a solenoid lever 233 that is rotatable about a support shaft 235, and a biasing spring that biases the solenoid lever 233 in a predetermined direction (the direction of the arrow in the diagram). The solenoid lever 233 rotates about the support shaft 235 as a plunger 236 of the solenoid 232 moves. The solenoid lever 233 is an example of a driving member connected to the solenoid 232 (driving source). The abutting unit 234 is fixed to the frame of the apparatus main body 1A.

The stoppers 101 are fixed to the stopper shaft 112. In the present exemplary embodiment, one stopper 101 is disposed on each side of the separation roller 34 in the rotation axis direction of the separation roller 34 (Y direction). The stopper shaft 112 is supported to be rotatable about the axis in the Y direction by the separation frame 343. The separation lever 121 and the rotation restriction lever 122 are disposed on an end of the stopper shaft 112. The separation lever 121 and the rotation restriction lever 122 protrude in respective difference directions intersecting the center axis of the stopper shaft 112. The separation lever 121 is an example of the member to be driven to which driving force is transmitted from the solenoid lever 233 serving as the driving member. The separation lever 121 serving as the member to be driven of the present exemplary embodiment is a unit to be pressed that is pressed by the solenoid lever 233.

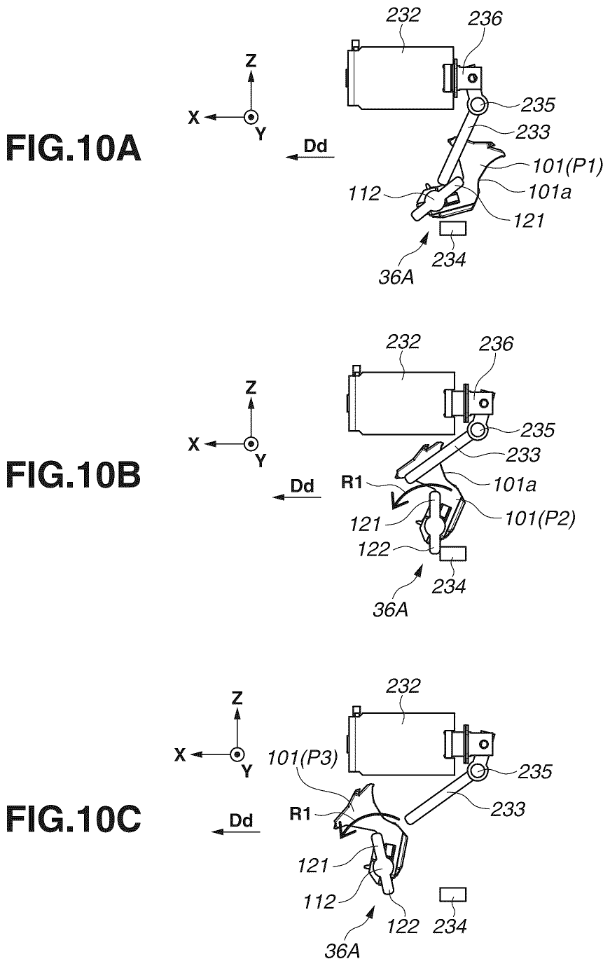

The stoppers 101 and the stopper shaft 112 are biased in a predetermined rotation direction R1 by a not-illustrated biasing member. The biasing member that biases the stoppers 101 and the stopper shaft 112 may be the nip pressure spring 342 or a spring other than the nip pressure spring 342. The rotation direction R1 is the direction in which the stoppers 101 move from the restriction position P1 toward the non-restriction position P2 (FIGS. 10A and 10B).

The stopper gear 105 is fixed to the stopper shaft 112. The stopper gear 105 is connected to the roller holder gear 103 via the idler gear 108.

The stopper shaft 112, the roller holder gear 103, the stopper gear 105, and the idler gear 108 function as a transmission mechanism for transmitting the driving force that the separation lever 121 (member to be driven) receives from the solenoid lever 233 (driving member) of the apparatus main body 1A. The transmission mechanism of the present exemplary embodiment includes the stopper shaft 112 serving as a shaft unit to which the separation lever 121 (member to be driven) and the stoppers 101 are attached. The transmission mechanism of the present exemplary embodiment also includes an engagement portion 103a to engage with the roller holder 341 (holder member) and a gear train (103, 105, and 108) for transmitting the driving force from the stopper shaft 112 (shaft unit) to the engagement portion 103a.

### Feed Operation

The operation of the separation unit 36A according to the present exemplary embodiment during the feed operation will be described with reference to FIGS. 10A and 10B. FIG. 10A is a diagram illustrating the separation unit 36A before the start of the feed operation, with the sheet cassette 31 mounted on the apparatus main body 1A. FIG. 10B is a diagram illustrating the separation unit 36A during the feed operation, with the sheet cassette 31 mounted on the apparatus main body 1A. FIGS. 10A to 10C are views from a point of view opposite to that of FIGS. 6A to 6C and 7A to 7C in the Y direction.

As illustrated in FIG. 10A, in the state before the start of the feed operation, the solenoid 232 is energized to retract the plunger 236 leftward in the diagram. The retraction of the plunger 236 maintains the solenoid lever 233 rotated counterclockwise in the diagram about the support shaft 235. The end of the solenoid lever 233 presses the separation lever 121 of the separation unit 36A, whereby the stopper shaft 112 is maintained rotated at a predetermined rotation angle opposite the rotation direction R1 against the biasing force of the biasing member, and the stoppers 101 are held at the restriction position P1. While the stoppers 101 are maintained at the predetermined rotation angle, the rotation of the roller holder gear 103 connected to the stopper gear 105 on the stopper shaft 112 via the idler gear 108 is also restricted. In such a case, the roller holder 341 is positioned with the separation roller 34 at the separated position.

The energization of the solenoid 232 is thus controlled so that the stoppers 101 are held at the restriction position P1 and the separation roller 34 is held at the separated position in the state before the start of the feed operation.

When the feed operation is started, the energization of the solenoid 232 is stopped at predetermined timing synchronized with the driving of the feed unit 35 by the motor M1 (FIG. 3). With the energization of the solenoid 232 stopped, the retraction of the plunger 236 ends. As illustrated in FIG. 10B, the stopper shaft 112 and the stoppers 101 then rotate in the rotation direction R1 (counterclockwise in the diagram) that is the biasing direction of the biasing member. The rotation of the stopper shaft 112 and the stoppers 101 is stopped by the rotation restriction lever 122 abutting against the abutting unit 234. The stoppers 101 thereby move from the restriction position P1 to the non-restriction position P2. The rotation of the stopper shaft 112 also rotates the roller holder gear 103 via the stopper gear 105 and the idler gear 108, and the roller holder 341 rotates so that the separation roller 34 moves from the separated position to the contact position.

The energization of the solenoid 232 is thus controlled so that the stoppers 101 move from the restriction position P1 to the non-restriction position P2 and the separation roller 34 moves from the separated position to the contact position after the start of the feed operation.

With the stoppers 101 at the non-restriction position P2 and the separation roller 34 at the contact position, the feed unit 35 feeds sheets S from the sheet cassette 31. Here, like the first exemplary embodiment, the separation roller 34 separates the sheets S by allowing the topmost sheet S1 to pass through the separation nip Ns and preventing the sheet(s) S other than the topmost sheet S1 from passing through the separation nip Ns. The stoppers 101 are located at the non-restriction position P2 retracted from the conveyance path of the sheets S and allows the topmost sheet S1 to be conveyed through the separation nip Ns.

The energization of the solenoid 232 is then resumed, and the plunger 236 is retracted leftward as illustrated in FIG. 10A. The retraction of the plunger 236 rotates the solenoid lever 233 counterclockwise in the diagram about the support shaft 235. The end of the solenoid lever 233 presses the separation lever 121 of the separation unit 36A, whereby the stopper shaft 112 is rotated opposite the rotation direction R1 against the biasing force of the biasing member, and the stoppers 101 move from the non-restriction position P2 to the restriction position P1. In the process of the stoppers 101 moving from the non-restriction position P2 to the restriction position P1, the contact surfaces 101a of the stoppers 101 come into contact with the leading edge(s) of the sheet(s) S taken to near the separation nip Ns during feeding of the topmost sheet S1. The stoppers 101 then push back the leading edge(s) of the sheet(s) S to a position upstream of the separation nip Ns while moving to the restriction position P1 (FIG. 6A).

The rotation of the stopper shaft 112 due to the resumed energization of the solenoid 232 also rotates the roller holder gear 103 connected to the stopper gear 105 on the stopper shaft 112 via the idler gear 108. The roller holder 341 is thereby rotated so that the separation roller 34 moves from the contact position to the separated position. This completes the feed operation of a single sheet.

In feeding a plurality of sheets S in succession, the foregoing feed operation is repeated sheet by sheet. Even when the feed operation is repeated, the stoppers 101 repeat the operation of pushing back the sheet(s) S other than the topmost sheet S1 to be fed by the current feed operation sheet by sheet. This can reliably prevent multiple sheet feeding compared to the case where the stoppers 101 are not used.

### Operation During Insertion and Removal of Cassette

Next, the operation of the separation unit 36A when the sheet cassette 31 is inserted into and removed from the apparatus main body 1A will be described with reference to FIGS. 10B and 10C. FIG. 10C is a diagram illustrating an intermediate state where the sheet cassette 31 is being drawn out from the apparatus main body 1A.

As illustrated in FIG. 10C, when the sheet cassette 31 starts to move from the mounting position in the drawing direction Dd, the separation lever 121 of the separation unit 36A is separated from the solenoid lever 233 of the apparatus main body 1A. Since the separation lever 121 is released from the solenoid lever 233, the rotation restriction on the stopper shaft 112 is lifted, and the stopper shaft 112 is rotated opposite the rotation direction R1 by the biasing force of the biasing member. In other words, the stoppers 101 move from the restriction position P1 (FIG. 10A) toward the non-restriction position P2.

As the stopper shaft 112 rotates, the roller holder 341 rotates in the direction where the separation roller 34 approaches the feed roller 33.

In other words, when the sheet cassette 31 is drawn out from the apparatus main body 1A, the separation roller 34 starts to move from the separated position toward the contact position like when the energization of the solenoid 232 is stopped during the feed operation. Moreover, when the sheet cassette 31 is drawn out from the apparatus main body 1A, the stoppers 101 start to move from the restriction position P1 toward the non-restriction position P2 like when the energization of the solenoid 232 is stopped during the feed operation.

Unlike the feed operation, when the sheet cassette 31 is drawn out from the apparatus main body 1A, the roller holder 341 does not stop at the position where the separation roller 34 comes into contact with the feed roller 33. The roller holder 341 rotates beyond the position where the separation roller 34 comes into contact with the feed roller 33 during the feed operation, and stops upon abutting against the feed guide 314.

While the roller holder 341 rotates beyond the position where the separation roller 34 comes into contact with the feed roller 33 during the feed operation, the stoppers 101 also rotate counterclockwise in FIGS. 10B. As illustrated in FIG. 10C, the retracted position P3 that is the position of the stoppers 101 in the state where the sheet cassette 31 is drawn out from the apparatus main body 1A therefore lies downstream of the non-restriction position P2 in the moving direction of the stoppers 101 from the restriction position P1 toward the non-restriction position P2.

In other words, the rotation angle of the roller holder 341 about the rotation shaft 341a when the sheet cassette 31 is drawn out from the apparatus main body 1A is greater than that of the roller holder 341 about the rotation shaft 341a during the feed operation. Moreover, the rotation angle of the stoppers 101 about the stopper shaft 112 when the sheet cassette 31 is drawn out from the apparatus main body 1A is greater than that of the stoppers 101 about the stopper shaft 112 during the feed operation.

As describe above, with the sheet cassette 31 drawn out from the apparatus main body 1A, the stoppers 101 are located at the retracted position P3 further retracted from the non-restriction position P2 for allowing sheets S to pass during the feed operation. This makes the stoppers 101 less likely to interfere with the sheet replenishment work for the sheet cassette 31 in the state where the sheet cassette 31 is drawn out from the apparatus main body 1A, and can improve the workability.

### Summary of Present Exemplary Embodiment

As described above, according to the configuration of the present exemplary embodiment, a new form of sheet feeding apparatus and image forming apparatus where the stoppers 101 (return members) are disposed on the sheet cassette 31 rather than on the apparatus main body 1A can be provided.

According to the present exemplary embodiment, in the state where the sheet cassette 31 is drawn out from the apparatus main body 1A, the stoppers 101 (return members) are located at the retracted position P3 (third position) further retracted from the non-restriction position P2. The user's hands and sheets S are thus prevented from touching the stoppers 101 in replenishing the sheet cassette 31 with the sheets S or taking out the sheets S. This enables smooth work without damaging the sheets S.

With the sheet cassette 31 mounted on the apparatus main body 1A, the stoppers 101 move between the restriction position P1 (first position) and the non-restriction position P2 (second position) that is closer to the restriction position P1 than the retracted position P3 (third position) is. The amount of movement of the stoppers 101 in the feed operation is thus smaller than that of the stoppers 101 when the sheet cassette 31 is inserted into and removed from the apparatus main body 1A. This can improve the throughput (number of sheets fed per unit time) of the sheet feeding unit 30, and enables the printer 1 to accommodate higher speeds.

Moreover, in the present exemplary embodiment, the separation unit 36A is driven by using the driving source (solenoid 232) different from the driving source (motor M1) for driving the feed unit 35. The contact and separation of the separation roller 34 with/from the feed roller 33 and the position of the stoppers 101 can thus be controlled at desired timing regardless of the operation state of the feed unit 35. For example, after the start of the feed operation, the timing to separate the separation roller 34 from the feed roller 33 is controlled based on timing when a sensor located upstream of the registration roller pair 4 detects the leading edge of the sheet S. This can control the opening timing of the separation nip Ns to reduce back tension occurring on the sheet S between the separation nip Ns and the registration roller pair 4, without being affected by variations in the sheet conveyance timing (early arrival or delay).

### Modification

Instead of the solenoid 232 and the solenoid lever 233 according to the second exemplary embodiment, a rotatable cam (driving member), a cam motor (driving source) for driving the cam to rotate, and a detection unit for detecting the phase of the cam may be used. The cam can contact and separate from the separation lever 121 of the separation unit 36. The cam is configured to, in the state where the sheet cassette 31 is mounted on the apparatus main body 1A, press the separation lever 121 to move the stoppers 101 from the restriction position P1 to the non-restriction position P2. The control unit of the printer 1 can implement operation similar to that of the separation unit 36A during the feed operation according to the second exemplary embodiment by driving the cam motor based on the detection result of the detection unit. Even in this modification, when the sheet cassette 31 is drawn out from the apparatus main body 1A, the separation lever 121 is separated from the cam and the stoppers 101 move to the retracted position P3. Advantages similar to those of the second exemplary embodiment can thus be obtained.

### Other Exemplary Embodiments

In the foregoing exemplary embodiments, the sheet feeding unit 30 that is a sheet feeding apparatus built in the printer 1 (image forming apparatus) has been described. However, this is not restrictive. The techniques according to the foregoing exemplary embodiments may be applied to a sheet feeding apparatus that includes a housing independent of the apparatus main body of the image forming apparatus and can feed sheets to the apparatus main body of the image forming apparatus. In such a case, the “apparatus main body” may refer to the housing of the sheet feeding apparatus that is connected to the apparatus main body of the image forming apparatus.

According to an exemplary embodiment of the present disclosure, a new form of sheet feeding apparatus and image forming apparatus concerning a return member that pushes back sheets can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-133937, filed Aug. 9, 2024, which is hereby incorporated by reference herein in its entirety.

What is claimed is:

1. A sheet feeding apparatus comprising:
an apparatus main body;
a cassette configured to accommodate a sheet and withdrawably mounted on the apparatus main body, the cassette including a return member configured to move to a first position and a second position;
a feed member configured to feed the sheet in a sheet feeding direction; and
a separation member configured to form a nip portion with the feed member, the separation member being configured to allow a first sheet with which the feed member is in contact to pass through the nip portion,
wherein the separation member is configured to, when at least one second sheet is conveyed to the nip portion along with the first sheet, prevent the at least one second sheet from passing through the nip portion, and
wherein the return member is configured to, in a state where the cassette is mounted on the apparatus main body, move from the second position to the first position so that the at least one second sheet is pushed back upstream of the nip portion in the sheet feeding direction.

2. The sheet feeding apparatus according to claim 1, wherein the cassette is configured to be drawn out from the apparatus main body downstream in the sheet feeding direction.

3. The sheet feeding apparatus according to claim 1, wherein the return member is configured to, in a state where the cassette is drawn out from the apparatus main body, be located at a third position downstream of the second position in a moving direction from the first position toward the second position.

4. The sheet feeding apparatus according to claim 3,
wherein the cassette includes a guide member located upstream of the nip portion in the sheet feeding direction, the guide member being configured to guide a lower surface of the sheet from an accommodation space in the cassette toward the nip portion, and
wherein, when viewed in a direction of a rotation axis of the feed member with the return member located at the third position, the return member is located entirely below a top surface of the guide member.

5. The sheet feeding apparatus according to claim 3, further comprising:
a driving source disposed on the apparatus main body;
a driving member disposed on the apparatus main body and connected to the driving source; and
a member to be driven disposed on the cassette and connected to the return member,
wherein, when the cassette is mounted on the apparatus main body, the driving member engages with the member to be driven and transmits driving force of the driving source, whereby the return member is moved between the first position and the second position, and
wherein, when the cassette is drawn out from the apparatus main body, the driving member and the member to be driven are separated from each other.

6. The sheet feeding apparatus according to claim 5, further comprising a biasing member disposed on the cassette, the biasing member being configured to bias the return member in the moving direction from the first position toward the second position,
wherein, in a state where the driving member and the member to be driven are separated from each other, the return member is located at the third position by biasing force of the biasing member.

7. The sheet feeding apparatus according to claim 6, wherein the biasing member is a spring member configured to press the separation member against the feed member to form the nip portion.

8. The sheet feeding apparatus according to claim 5, wherein, when the cassette drawn out of the apparatus main body is inserted into the apparatus main body, the driving member comes into contact with the member to be driven, whereby the return member is moved from the third position to the first position.

9. The sheet feeding apparatus according to claim 5,
wherein the driving source is a motor,
wherein the driving member is a cam configured to be rotated by the driving force of the motor, and
wherein the member to be driven is a cam follower configured to be moved by contact with the cam.

10. The sheet feeding apparatus according to claim 5,
wherein the driving source is a solenoid,
wherein the driving member is a lever configured to be swung by the driving force of the solenoid, and
wherein the member to be driven is a unit to be pressed configured to be pressed by the lever.

11. The sheet feeding apparatus according to claim 5, further comprising:
a holder member disposed on the cassette, the holder member being configured to hold the separation member and move so that the separation member comes into contact with and separates from the feed member; and
a transmission mechanism disposed on the cassette, the transmission mechanism being configured to transmit the driving force received by the member to be driven to the holder member and the return member,
wherein the transmission mechanism is configured to, in the state where the cassette is mounted on the apparatus main body, move the holder member so that the separation member comes into contact with the feed member in a manner interlocked with movement of the return member from the first position to the second position.

12. The sheet feeding apparatus according to claim 11, wherein the transmission mechanism includes a first shaft unit to which the member to be driven is attached, a second shaft unit to which the return member is attached, an engagement portion configured to engage with the holder member, and a gear train configured to transmit the driving force from the first shaft unit to the second shaft unit and the engagement portion.

13. The sheet feeding apparatus according to claim 11, wherein the transmission mechanism includes a shaft unit to which the member to be driven and the return member are attached, an engagement portion configured to engage with the holder member, and a gear train configured to transmit the driving force from the shaft unit to the engagement portion.

14. The sheet feeding apparatus according to claim 1, further comprising a pickup roller located above an accommodation space in the cassette, the accommodation space being configured to accommodate sheets, the pickup roller being configured to feed the first sheet in the sheet feeding direction, the first sheet being a topmost one of the sheets accommodated in the accommodation space,
wherein the feed member is a feed roller disposed downstream of the pickup roller in the sheet feeding direction, and
wherein the separation member is a separation roller connected to a shaft fixed to a frame of the cassette via a torque limiter.

15. An image forming apparatus comprising:
the sheet feeding apparatus according to claim 1; and
an image forming unit configured to form an image on the sheet fed from the sheet feeding apparatus.
